(19) United States
(12) Patent Application Publication
(10) Pub. No.: US 2018/0061512 A1
(43) Pub. Date: Mar. 1, 2018

(54) Reactor Control Rod Driving Mechanism

(71) Applicant: Sichuan Huadu Nuclear Equipment Manufacture Co., Ltd., Chengdu (CN)

(72) Inventors: Jie Yu, Chengdu (CN); Hongying Li, Chengdu (CN); Qing Zhu, Chengdu (CN); Ying Luo, Chengdu (CN); Zewen Li, Chengdu (CN); Xinan Chen, Chengdu (CN); Maofu Liu, Chengdu (CN); Tianda Yu, Chengdu (CN)

(21) Appl. No.: 15/687,486

(22) Filed: Aug. 27, 2017

(30) Foreign Application Priority Data
Aug. 31, 2016 (CN) 201621001183X

(51) Int. Cl. G21C 7/12

(52) U.S. Cl. CPC G21C 7/12

(57) ABSTRACT

A control rod driving mechanism, comprising a sealing shell assembly, a travel casing fixedly connected to the sealing shell assembly, a coil assembly sleeved on the sealing shell assembly, and a hook assembly disposed in the sealing shell assembly, wherein the sealing shell assembly comprises a sealing shell and a tube base, and the sealing shell and the tube base form an integral structure. The integral structure eliminates the process for welding the tube base to the sealing shell. In this way, the time for manufacturing and assembling the overall reactor might be saved. Also, compared with the prior art, the reactor employing such scheme would reduce one nuclear first class weld, lowering the risk of leakage. In sum, the structure described above extends the service life of the control rod driving mechanism, and remarkably decreases the work for in-service inspection of the control rod driving mechanism.

### FIELD OF THE INVENTION

The invention relates to the technical field of reactor assembly, and specifically relates to a reactor control rod driving mechanism.

### BACKGROUND OF THE INVENTION

With the development of nuclear electricity, the share of nuclear electricity generation rises, causing the share of peak regulation of nuclear electricity to increase. The core power of a pressured water reactor power plant is regulated mainly through regulating control rods, changing concentration of boron and the like so as to perform peak regulation. Therefore the control rod driving mechanism plays an important role in regulating the power of the pressured water reactor.

The service life of the existing control rod driving mechanism, for example the ML-B model (ACP1000), is more than 15 million steps. However, in a life testing experiment, the ML-B model (ACP1000) reached an end of life due to the fracture and invalidation of the buffer shaft in hook assembly as the number of steps reached 15.12 million. The buffer shaft in another models of the control rod driving mechanism is also a weak part, therefore the service life of the buffer shaft directly restricts the service life of the control rod driving mechanism. Meanwhile, the existing control rod driving mechanism has to be provided with a specialized cooling system for cooling coil assembly causing the control rod driving mechanism to be bulky, complicated and difficult to be installed and maintained. Further, as the pressure assembly of the control rod driving mechanism, the manufacture and assembly quality of the sealing shell assembly directly affects the service life of the control rod driving mechanism. Consequently, further optimizing the structure of the control rod driving mechanism so as to improve the service life of the hook assembly that includes the buffer shaft is pursued by people skilled in the field of designing and manufacturing nuclear equipments.

### BRIEF SUMMARY OF THE INVENTION

In order to further optimize the structure of the control rod driving mechanism so as to further improve the service life of the hook assembly, the present invention provides a reactor control rod driving mechanism. By virtue of the technical schemes disclosed in the present invention, the service life of the control rod driving mechanism can be extended by optimizing the structure thereof.

In some embodiments of the present invention, the control rod driving mechanism includes a sealing shell assembly, a travel casing fixedly connected to the sealing shell assembly, a coil assembly sleeved on the sealing shell assembly, and a hook assembly disposed in the sealing shell assembly, wherein the sealing shell assembly comprises a sealing shell and a tube base, and the sealing shell and the tube base form an integral structure.

Specifically, in the prior art, the sealing shell assembly that disposed in the control rod driving mechanism only comprises a sealing shell, which means a tube base is independent of the control rod driving mechanism. The tube base is welded to a pressure vessel as the pressure vessel is manufactured. As a result, in the installation process of the control rod driving mechanism, welding workers need to weld the tube base to the sealing shell on the installation site. Moreover, in the prior art, the sealing shell and the tube base commonly employ different metals. A nuclear first class weld would therefore be created at the junction of the sealing shell and tile tube base, not only complicating the welding process, but also remarkably increasing the work for in-service inspection of the control rod driving mechanism.

In such technical scheme, the sealing shell and the tube base together form an integral structure. When the control rod driving mechanism is connected to the pressure vessel, the process for welding the tube base to the sealing shell is eliminated. Thus the time for manufacturing and assembling the overall reactor can be saved. Also, compared with the prior art, the reactor employing such scheme would reduce one nuclear first class weld, lowering the risk of leakage. In sum, the structure described above can extend the service life of the control rod driving mechanism, and remarkably decrease the work for in-service inspection of the control rod driving mechanism.

Furthermore, as the particular implementation model of the hook assembly, in another embodiments, the hook assembly comprises a buffer shaft and a movable armature, and each of the buffer shaft and the movable armature has a cylindrical structure. The buffer shaft is a stepped shaft, and the movable armature comprises an inner bore in a form of a stepped bore. The movable armature is sleeved onto an outer side of the buffer shaft, and a first diameter changing section of the outer side of the buffer shaft faces directly to a second diameter changing section of the inner bore of the movable armature. When the buffer shaft and the movable armature move relative to each other, a relative position of the buffer shaft and the movable armature is limited due to a contact between the first diameter changing section and the second diameter changing section. The first diameter changing section is connected to a smaller diameter end of the buffer shaft through a rounding or a first chamfer, wherein a size of the rounding comprises ranges from R0.6 to R5, and a size of the first chamfer ranges from 2×45° to 4×45°.

In the hook assembly, one end of the hook is connected to the buffer shaft via a first pin, while the other end of the hook is connected to a connecting rod via a second pin, wherein the connecting rod is connected to the movable armature via a third pin. The aforementioned connections are hinge connections. The movable armature and the buffer shaft cooperate with each other, ensuring the operating accuracy of the hook due to the completeness of the structure and the size of the movable armature and the buffer shaft. When the movable armature separates from the lifting armature without an external magnetic force, the movable armature moves down under the action of gravity and spring force. The first diameter changing section contacts with the second diameter changing section, allowing the buffer shaft to limit the distance and the radian of the movement of the movable armature, and further causing the hook to move to the a certain position. The hook is driven by the connecting rod controlled by the movement of the movable armature. In this way, the accuracy and the efficiency of every movement of the hook can be ensured. In the aforementioned process, the first diameter changing section impacts on the second diameter changing section, and such impact is the main reason for the invalidation of the buffer shaft.

After installation, a lifting armature of the hook assembly is located above the movable armature, and a spring is located between the lifting armature and the movable armature. The second diameter changing section is located above the first diameter changing section. The end of the buffer shaft that has a smaller diameter is the upper end of the buffer shaft. Thus when the movable armature moves down, the movable armature slides along the upper end of the buffer shaft. Later, the second diameter changing section would contact with the first diameter changing section, enabling the buffer shaft to limit the movement of the movable armature.

In such structure, the first diameter changing section is connected to a smaller diameter end of the buffer shaft, i.e. the upper end of the buffer shaft, through a rounding or a first chamfer. When the first diameter changing section and the second diameter changing section impact each other, the rounding or the first chamfer is used to reduce or eliminate the stress concentration occurred at the connecting point of the first diameter changing section and the upper end of the buffer shaft. After the stress concentration is reduced or eliminated, either the premature initiation of partial crack or fracture occurred on the buffer shaft, or the abnormal abrasion in the inner bore of the buffer shaft can be avoided. Person having ordinary skill in the art would appreciate that the rounding having larger radius or the first chamfer having larger size would be more efficient on eliminating the stress concentration. Nonetheless, the buffer shaft in the prior art has a certain size. Hence the lager rounding or first chamfer might lead to a smaller effective contact area between the first diameter changing section and the second diameter changing section. Under a same external force, the smaller effective contact area can increase wear rate per unit, reducing the wear resistance of the movable armature and the buffer shaft, invalidating the radial positioning and the axial positioning between the movable armature and the buffer shaft, lowering the accuracy of the movement of the hook, and even causing the control rod driving mechanism to be step-out, slip or even get stuck. Consequently, the reactor core power regulation and the urgent shutdown function might be influenced. In view of the area of the matching surface of the buffer shaft and the movable armature, i.e. the effective contact area of the first diameter changing section and the second diameter changing section, the size of the rounding further ranges from R0.6 to R5, wherein R refers to radius of the rounding, and the size of the first chamfer ranges from 2×45° to 4×45°. The abovementioned sizes might cause the wear rate of the matching surface to match the number of collisions that the buffer shaft can afford. Namely, the designed structure of the buffer shaft can increase the number of operation steps of the buffer shaft, while the wear resistance of the matching surface of the buffer shaft and the movable armature can also allow such increase.

The buffer shaft could be a stepped shaft comprising two segments. Namely, the outer side of the buffer shaft only includes one diameter changing section, i.e. the first diameter changing section. And a smaller diameter end of the buffer shaft is the upper end of the buffer shaft. The inner bore of the movable armature could be a stepped bore comprising three segments, wherein the middle one protrudes relative to the others. So that the stepped bore of the movable armature has two diameter changing sections. After the installation of the movable armature, the upper diameter changing section is the bearing surface of the spring while the lower diameter changing section is the second diameter changing section used to limit the relative position of the movable armature and the buffer shaft.

In some embodiments, the coil assembly comprises an inner frame and an outer shell each having a cylindrical structure, and an annular cavity for accommodating a coil winding formed between the outer shell and the inner frame. The inner frame is disposed in an inner hole of the outer shell. Each of the inner frame and the outer shell comprises a metal body portion and one or more break grooves disposed on the body portion. The break grooves of the inner frame extend through an inner wall, an outer wall, a front end face and a rear end face of the inner frame; while the break grooves of the outer shell extend through an inner wall, an outer wall, a front end face and a rear end face of the outer shell.

In the abovementioned technical scheme, the metal body portion of the inner frame and the break grooves disposed on the body portion of the inner frame constitute the cylindrical structure of the inner frame. And the metal body portion of the outer shell and the break grooves disposed on the body portion of the outer shell constitute the cylindrical structure of the outer shell. The cavity located between the inner frame and the outer shell is to accommodate the coil winding. When the coil winding is in use, the break grooves of the inner frame or the outer shell cut off the inner frame or the outer shell, which means the break grooves are grooves disposed on the inner frame or the outer shell, and respectively used to cut off the inner frame or the outer shell, so as to prevent the eddy current appearing on the inner frame or the outer shell. In this way, the inner frame and the outer shell made of metal might replace those in the prior art that are made of polymeric nonmetal materials, so that the coil assembly can tolerant a temperature significantly higher than 350° C. Therefore, the metal materials provide longer service life of the inner frame and the outer shell. In addition, the air cooling system required in the prior art for cooling the coil assembly is of no use. Namely, the present invention can remove the air cooling system, simplifying the structure and saving the cost, while improving the thermal efficiency of the reactor as no heat is removed by cooling medium.

In another embodiments, the one or more break grooves of the inner frame or the outer wall comprise at least two break grooves. The break grooves of the inner frame are distributed evenly on the body portion of the inner frame, and the break grooves of the outer shell are distributed evenly on the body portion of the outer shell. An insulative connecting strip is disposed in each one of the break grooves. Such technical scheme further limiting the amount of break grooves is to cause a more even magnetic field occurring on the coil assembly. Moreover, the insulative connecting strip facilitates to maintain the structure of the inner frame and the outer shell. Preferably, the break grooves are distributed evenly on the body portion of the inner frame and the outer shell, causing the magnetic field extending from the inner frame or the outer shell to be completely even when the electromagnetic coil is in use. Thus the rotating tendency of the movable parts disposed in the control rod driving mechanism can be weakened or eliminated during their axial movements. As a result, the eccentric wear and excessive partial abrasion might be relieved or eliminated, improving the movement performance of the control rod driving mechanism.

As the base for fixing the electromagnetic coil winding, the inner frame could just be a whole cylindrical structure for installation and utilization. One specific technical scheme facilitating the manufacture of the inner frame is that the insulative connecting strip of the inner frame comprises an insulating strip embedded or inlaid in the break grooves of the inner frame. Since the outer shell is to protect the electromagnetic coil winding, it should be installed at the outer side of the electromagnetic coil winding after the electromagnetic coil winding is installed. As one specific technical scheme facilitating the installation of the outer shell, two engagement grooves or two engagement convex portions disposed on the outer shell are respectively located on two sides of each one of the break grooves of the outer shell. A longitudinal direction of the engagement grooves or the engagement convex portions is in parallel with an axial direction of the outer shell. The engagement grooves or the engagement convex portions originate at one end of the outer shell. The insulative connecting strip of the outer shell comprises an insulating engagement strip connecting to two engagement grooves or the engagement convex portions of any one of the break grooves of the outer shell. The insulating engagement strip restricts the corresponding engagement grooves or the engagement convex portions, uniting the parts of outer shell together. Without the restriction, the parts of the outer shell would separate from each other.

In order to completely eliminate the asymmetric electromagnetic component force created by the magnetic field in the radial direction, the amount of the break grooves of the inner frame and the amount of the break grooves of the outer shell are multiples of each other, wherein the value of the multiples is a positive integer. With the limitation of the amount of the break grooves of the inner frame and the outer shell, the uneven electromagnetic component force in each radial direction of the electromagnetic coil assembly can be canceled out, so as to completely eliminate the eccentric wear, excessive partial abrasion and stress generated on the anti-rotation stop due to the asymmetric magnetic field created by electromagnetic coil.

In some embodiments, in order to create a completely even magnetic field, the amount of the break grooves of the inner frame equals to the amount of the break grooves of the outer shell. The location of one of the break grooves of the inner frame should correspond to the location of one of the break grooves of the outer shell. Namely, one of the break grooves of the inner frame and one of the break grooves of the outer shell locate at the same radial direction of the structure of the electromagnetic coil.

As a specific form of connection between the inner frame and the outer shell, two annular outer edges are respectively disposed on two ends of the inner frame. An axis of the outer edges and an axis of the body portion of the inner frame are collinear. An inner hole of the outer edges is connected to the two ends of the inner frame. The break grooves of the inner frame extend to an outer end of the outer edges. An external diameter of the outer shell is no more than an external diameter of the outer edges, and the outer shell is engaged between the two outer edges. An insulating layer is disposed between each one of the outer edges and a corresponding end of the outer shell; and the annular cavity is an enclosed structure. With the aforementioned connecting form, the relative position of the inner frame and the outer shell can be firmly fixed, facilitating to keep the performance of the electromagnetic coil. The enclosed structure of the annular cavity aims to protect the electromagnetic coil winding.

In some embodiments, a second chamfer is disposed on a smaller diameter end of the second diameter changing section of the inner bore of the movable armature. The second diameter changing section comprises a smaller diameter end and a larger diameter end, wherein the smaller diameter end thereof is close to the inner bore of the movable armature, while the larger end thereof is away from the inner bore. The size of the second chamfer ranges from 2.5×45° to 3.2×45°. Such technical scheme enables the buffer shaft to operate 17 million steps.

To obtain a high strength structure, each of the sealing shell and the tube base has a tubular structure forged by a nickel based alloy material. Person haying ordinary skill in the art would appreciate that an integral tubular structure uniting the sealing shell and the tube base could be manufactured by 3D printing with the nickel based alloy material.

As an implementation model of the buffer shaft and movable armature having a high strength and good wear resistance, a material of the buffer shaft is any of an austenitic stainless steel, a nickel based alloy or a cobalt based alloy. The movable armature is consisted of a martensitic stainless steel.

For facilitating indication of the control rod, the present invention further comprises a rod position indicating assembly sleeved onto the sealing shell assembly. As an implementation mode of a small rod position indicating assembly that is convenient to be installed, the rod position indicating assembly is a magnetostriction displacement sensor. Namely, a permanent magnet fixed on a free end of the driving rod connected to the control rod is used as the movable magnetic ring of the magnetostriction displacement sensor. And the measuring element and the signal processing module of the magnetostriction displacement sensor are disposed on the outer side of the travel casing.

In sum, the present invention has the following advantages and beneficial effects: the sealing shell and the tube base constitute an integral structure, eliminating the process for welding the tube base to the sealing shell during the connection of the control rod driving mechanism and the pressure vessel. In this way, the time for manufacturing and assembling the overall reactor is saved. Also, compared with the prior art, the reactor employing such scheme would reduce one nuclear first class weld, lowering the risk of leakage. In sum, the structure described above extends the service life of the control rod driving mechanism, and remarkably decreases the work for in-service inspection of the control rod driving mechanism.

### BRIEF DESCRIPTION OF THE DRAWINGS

Further advantages and features of the invention emerge from the following description of an illustrative embodiment, wherein:

FIG. 1 is a schematic structure diagram of one embodiment of the reactor control rod driving mechanism described in the present invention;

FIG. 2 is a schematic structure diagram of the hook assembly of the reactor control rod driving mechanism in one embodiment of the present invention;

FIG. 3 is a partial enlarged view of the part A shown in FIG. 2;

FIG. 4 is a section view of the coil assembly of the reactor control rod driving mechanism in one embodiment of the present invention;

FIG. 5 is a schematic structure diagram of the outer shell of the reactor control rod driving mechanism in one embodiment of the present invention;

FIG. 6 is a schematic structure diagram of the inner frame of the reactor control rod driving mechanism in one embodiment of the present invention.

### DETAILED DESCRIPTION OF THE PREFERRED EMBODIMENTS

The present invention would now be described more specifically with reference to the following embodiments. It is to be noted that the following descriptions of preferred embodiments of this invention are presented herein for purpose of illustration and description only. It is not intended to be exhaustive or to be limited to the precise form disclosed.

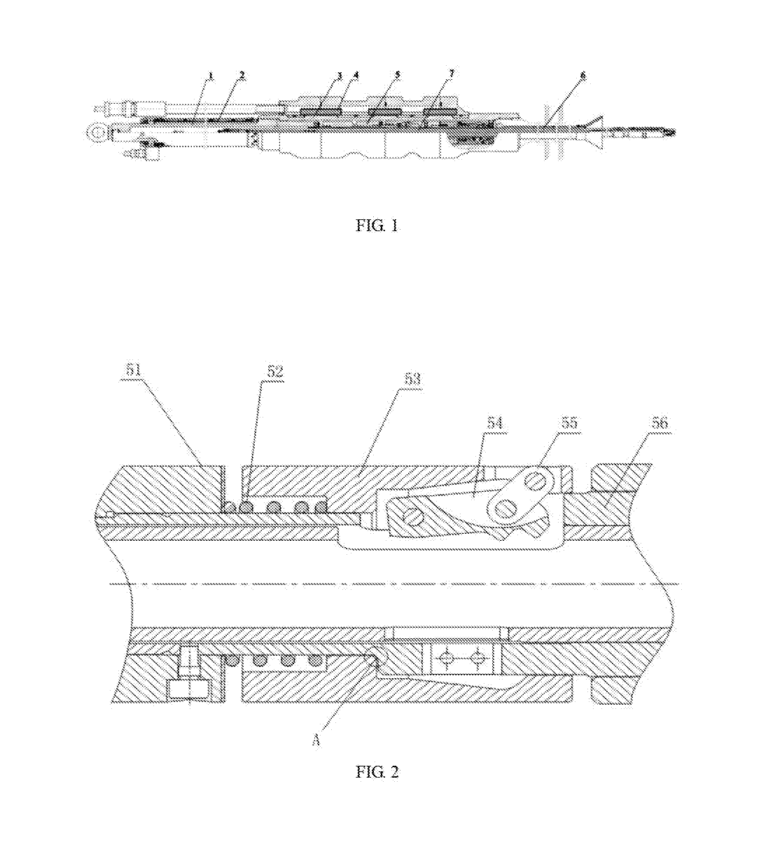

FIG. 1 is the schematic structure, diagram of the reactor central rod driving mechanism described in one embodiment. In FIG. 1, the control rod driving mechanism includes a sealing shell assembly 3, a travel casing 1 fixedly connected to the sealing shell assembly 3, a coil assembly 4 sleeved on the sealing shell assembly 3, and a hook assembly 5 disposed in the sealing shell assembly 3, wherein the sealing shell assembly 3 comprises a sealing shell and a tube base, and the sealing shell and the tube base form an integral structure.

Specifically, in the prior art, the sealing shell assembly 3 that disposed in the control rod driving mechanism only comprises a sealing shell, which means a tube base is independent of the control rod driving mechanism. The tube base is welded to a pressure vessel as the pressure vessel is manufactured. As a result, in the installation process of the control rod driving mechanism, welding workers need to weld the tube base to the sealing shell on the installation site. Moreover, in the prior art, the sealing shell and the tube base commonly employ different metals. A nuclear first class weld would therefore be created at the junction of the sealing shell and the tube base, not only complicating the welding process, but also remarkably increasing the work for in-service inspection of the control rod driving mechanism because of the existence of the insulating sleeve 6.

In such embodiment, the sealing shell and the tube base together form an integral structure. When the control rod driving mechanism is connected to the pressure vessel, the process for welding the lube base to the sealing shell can be eliminated. Thus the time for manufacturing and assembling the overall reactor might be saved. Also, compared with the prior art, the reactor employing such scheme would reduce one nuclear first class weld, lowering the risk of leakage. In sum, the structure described above extends the service life of the control rod driving mechanism, and remarkably decreases the work for in-service inspection of the control rod driving mechanism.

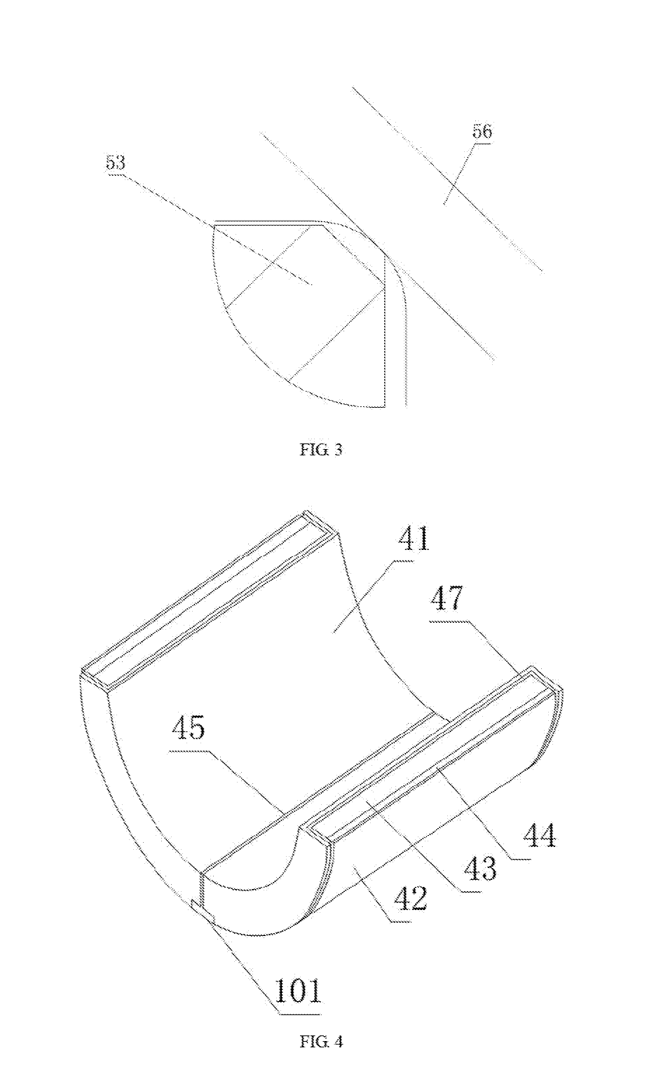

In FIG. 2 shows a schematic structure diagram of the hook assembly in another embodiment. In FIG. 2 and FIG. 3, Based on the aforementioned embodiment, such embodiment further defines that the hook assembly 5 comprises a buffer shaft 56 and a movable armature 53, and each of the buffer shaft 56 and the movable armature 53 has a cylindrical structure. The buffer shaft 56 is a stepped shaft, and the movable armature 53 comprises an inner bore in a form of a stepped bore. The movable armature 53 is sleeved onto an outer side of the buffer shaft 56, and a first diameter changing section of the outer side of the buffer shaft 56 faces directly to a second diameter changing section of the inner bore of fee movable armature 53. When the buffer shaft 56 and the movable armature 53 move relative to each other, a relative position of the buffer shaft 56 and the movable armature 53 is limited due to a contact between the first diameter changing section and the second diameter changing section. The first diameter changing section is connected to a smaller diameter end of the buffer shaft 56 through a rounding or a first chamfer, wherein a size of the rounding comprises ranges from R0.6 to R5, and a size of the first chamfer ranges from 2×45° to 4×45°.

In the hook assembly 5, one end of the hook 54 is connected to the buffer shaft 56 via a first pin, while the other end of the hook 54 is connected to a connecting rod 55 via a second pin, wherein the connecting rod 55 is connected to the movable armature 53 via a third pin. The aforementioned connections are hinge connections. The movable armature 53 and the buffer shaft 56 cooperate with each other, ensuring the operating accuracy of the hook 54 due to the completeness of the structure and the size of the movable armature 53 and the buffer shaft 56. When the movable armature 53 separates from the lifting armature 51 without an external magnetic force effect, the movable armature 53 moves down under the action of gravity and spring 52 force. The first diameter changing section of the outer side of the buffer shaft 56 contacts with the second diameter changing section of the inner bore of the movable armature 53, allowing the buffer shaft 56 to limit the distance and the radian of the movement of the movable armature 53, and further causing the hook 54 to move to the a certain position. The hook 54 is driven by the connecting rod 55 controlled by the movement of the movable armature 53. In this way, the accuracy and the efficiency of every movement of the hook 54 can be ensured. In the aforementioned process, the first diameter changing section impacts on the second diameter changing section, and such impaction is the main reason for the invalidation of the buffer shaft.

After installation, the lifting armature 51 of the hook assembly 5 is located above the movable armature 53, and a spring 52 is located between the lifting armature 51 and the movable armature 53. The second diameter changing section of the inner bore of the movable armature 53 is located above the first diameter changing section of the outer side of the buffer shaft 56. The end of the buffer shaft 56 that has a smaller diameter is the upper end of the buffer shaft 56. Thus when the movable armature 53 moves down the movable armature 53 slides along the upper end of the buffer shaft 56. Later, the second diameter changing section would contact with the first diameter changing section, enabling the buffer shaft 56 to limit the movement of the movable armature 53.

In such structure, the first diameter changing section is connected to a smaller diameter end of the buffer shaft 56, i.e. the upper end of the buffer shaft 56, through a rounding or a first chamfer. When the first diameter changing section and the second diameter changing section impact each other, the rounding or the first chamfer is used to reduce or eliminate the stress concentration occurred at the connecting point of the first diameter changing section and the upper end of the buffer shaft 56. With the smaller or null stress concentration, either the premature initiation of partial crack or fracture occurred on the buffer shaft 56, or the abnormal abrasion in the inner bore of the buffer shaft 56 can be avoided. Person having ordinary skill in the art would appreciate that the rounding having larger radius or the first chamfer having larger size would be more efficient on eliminating the stress concentration. Nonetheless, the buffer shaft 56 in the prior art has a certain size. Hence the lager rounding or first chamfer might lead to smaller effective contact area between the first diameter changing section and the second diameter changing section. Under a same external force, smaller effective contact area can increase the wear rate per unit, reducing the wear resistance of the movable armature 53 and the buffer shaft 56, invalidating the radial positioning and the axial positioning between the movable armature 53 and the buffer shaft 56, lowering the accuracy of the movement of the hook 54, and even causing the control rod driving mechanism to be step-out, slip or even get stuck. Consequently, the reactor core power regulation and the urgent shutdown function might be influenced. In view of the area of the matching surface of the buffer shaft 56 and the movable armature 53, i.e. the effective contact area of the first diameter changing section and the second diameter changing section, the size of the rounding further ranges from R0.6 to R5, and the size of the first chamfer ranges from 2×45° to 4×45°. The abovementioned sizes might cause the wear rate of the matching surface to match the number of collisions that the buffer shaft 56 is able to afford. Namely, the designed structure of the buffer shaft 56 increases the number of operation steps of the buffer shaft 56, while the wear resistance of the matching surface of the buffer shaft 56 and the movable armature 53 can also allow such increase. R0.6 described above means that the radius of the rounding is 0.6 mm. The 2×45° means that the first chamfer has an angle of 45° and a length of 2 mm. The aforementioned structure allows the operating steps of buffer shaft to reach 16 million steps.

The buffer shaft 56 could be a stepped shaft comprising two segments. Namely, the outer side of the buffer shaft 56 only includes one diameter changing section, i.e. the first diameter changing section. And a smaller diameter end of the buffer shaft 56 is the upper end of the buffer shaft. The inner bore of the movable armature 53 could be a stepped bore comprising three segments, wherein the middle one protrudes relative to the others. So that the stepped bore of the movable armature 53 has two diameter changing sections. After the installation of the movable armature 53, the upper diameter changing section is the bearing surface of the spring 52 while the lower diameter changing section is the second diameter changing section used to limit the relative position of the movable armature 53 and the buffer shaft 56.

As another embodiment of the second diameter changing section of the inner bore of the movable armature 53, a second chamfer is disposed on a smaller diameter end of the, second diameter changing section. The size of the second chamfer ranges from 2.5×45° to 3.2×45°. Such technical scheme enables the buffer shaft to operate 17 million steps.

To obtain a sealing shell assembly 3 with a high strength structure, each of the sealing shell and the tube base has a tubular structure forged by a nickel based alloy material.

As an implementation model of the buffer shaft 56 and movable armature 53 having a high strength and good wear resistance, a material of the buffer shaft 56 is any of an austenitic stainless steel, a nickel based alloy or a cobalt based alloy. The movable armature 53 is consisted of a martensitic stainless steel.

For facilitating indication of the control rod, the present invention further comprises a rod position indicating assembly 2 sleeved onto the sealing shell assembly 3. As an implementation mode of a small rod position indicating assembly 2 that is convenient to be installed, the rod position indicating assembly 2 is a magnetostriction displacement sensor. Namely, a permanent magnet fixed on a free end of the driving rod 7 connected to the fuel rod is used as the movable magnetic ring of the magnetostriction displacement sensor. And the measuring element and the signal processing module of the magnetostriction displacement sensor are disposed on the outer side of the travel casing 1.

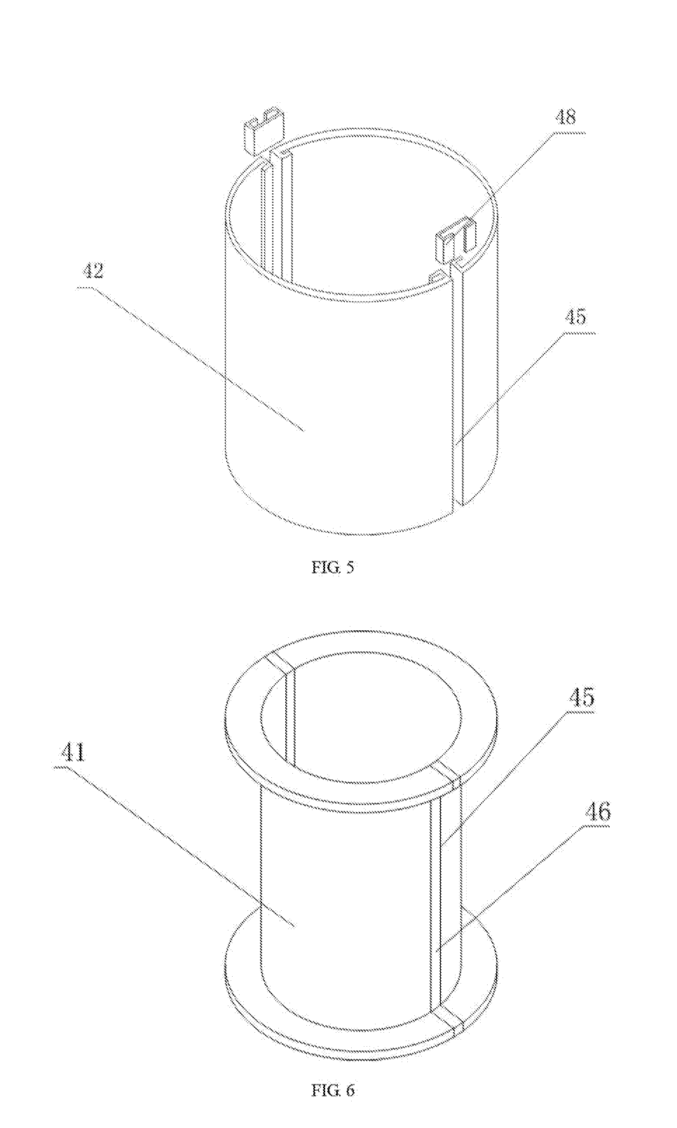

FIG. 4, FIG. 5 and FIG. 6 show another embodiment of the present invention. Such embodiment further defines the structure of the coil assembly 4. The coil assembly 4 comprises an inner frame 41 and an outer shell 42 each having a cylindrical structure, and an annular cavity for accommodating a coil winding 43 formed between the outer shell 42 and the inner frame 41. The inner frame 41 is disposed in an inner hole of the outer shell 42. Each of the inner frame 41 and the outer shell 42 comprises a metal body portion and one or more break grooves 45 disposed on the body portion. The break grooves 45 of the inner frame 41 extend through an inner wall, an outer wall, a front end face and a rear end face of the inner frame 41; while the break grooves 45 of the outer shell 42 extend through an inner wall, an outer wall, a front end face and a rear end face of the outer shell 42.

In the abovementioned technical scheme, the metal body portion of the inner frame 41 and the break grooves 45 disposed on the body portion of the inner frame 41 constitute the cylindrical structure of the inner frame 41. And the metal body portion of the outer shell 42 and the break grooves 45 disposed on the body portion of the outer shell 42 constitute the cylindrical structure of the outer shell 42. The cavity located between the inner frame 41 and the outer shell 42 is to accommodate the coil winding 43. When the coil winding 43 is in use, the break grooves 45 of the inner frame 41 or the outer shell 42 cut off the inner frame 41 or the outer shell 42, which means the break grooves 45 are grooves disposed on the inner frame 41 or the outer shell 42, and respectively used to cut off the inner frame 41 or the outer shell 42, so as to prevent the eddy current appearing on the inner frame 41 or the outer shell 42. In this way, the inner frame 41 and the outer shell 42 made of metal might replace those in the prior art that are made of polymeric nonmetal materials, so that the coil assembly 4 can tolerant a temperature significantly higher than 350° C. Therefore, the metal materials provide longer service life of the inner frame 41 and the outer shell 42. In addition, the air cooling system required in the prior art for cooling the coil assembly 4 is of no use. Namely, the present invention can remove the air cooling system, simplifying the structure and saving the cost, while improving the thermal efficiency of the reactor as no heat is removed by cooling medium.

The one or more break grooves 45 of the inner frame 41 or the outer wall 42 comprise at least two break grooves 45. The break grooves 45 of the inner frame 41 are distributed evenly on the body portion of the inner frame 41, and the break grooves 45 of the outer shell 42 are distributed evenly on the body portion of the outer shell 42. An insulative connecting strip is disposed in each one of the break grooves 45. Such embodiment further limiting the amount of break grooves 45 aims to cause a more even magnetic field occurring on the coil assembly 4. Moreover, the insulative connecting strip facilitates to maintain the structure of the inner frame 41 and the outer shell 42. Preferably, the break grooves 45 are distributed evenly on the body portion of the inner frame 41 and the outer shell 42, causing the magnetic field extending from the inner frame 41 or the outer shell 42 to be completely even when the electromagnetic coil is in use. Thus the rotating tendency of the movable parts disposed in the control rod driving mechanism can be weakened or eliminated during their axial movements. As a result, the eccentric wear and excessive partial abrasion might be relieved or eliminated, improving the movement performance of the control rod driving mechanism.

As the base for fixing the electromagnetic coil winding 43, the inner frame 41 could just be a whole cylindrical structure for installation and utilization. One specific technical scheme facilitating the manufacture of the inner frame 41 is that the insulative connecting strip of the inner frame 41 comprises an insulating strip 46 embedded or inlaid in the break grooves of the inner frame 41. Since the outer shell 42 is to protect the electromagnetic coil winding 43, it should be installed at the outer side of the electromagnetic coil winding 43 after the electromagnetic coil winding 43 is installed. As one specific technical scheme facilitating the installation of the outer shell 42, two engagement grooves or two engagement convex, portions disposed on the outer shell 42 are respectively located on two sides of each one of the break grooves 45 of the outer shell 42. A longitudinal direction of the engagement grooves or the engagement convex portions is in parallel with an axial direction of the outer shell 42. The engagement grooves or the engagement convex portions originate at one end of the outer shell 42. The insulative connecting strip of the outer shell 42 comprises an insulating engagement strip connecting to two engagement grooves or the engagement convex portions of any one of the break grooves of the outer shell 42. The insulating engagement strip 48 restricts the corresponding engagement grooves or the engagement convex portions, uniting the parts of outer shell 42 together. Without the restriction, the parts of the outer shell 42 would separate from each other.

In order to completely eliminate the asymmetric electromagnetic component force created by the magnetic field in the radial direction, the amount of the break grooves 45 of the inner frame 41 and the amount of the break grooves 45 of the outer shell 42 are multiples of each other, wherein the value of the multiples is a positive integer. With the limitation of the amount of the break grooves 45 of the inner frame 41 and the outer shell 42, the uneven electromagnetic component force in each radial direction of the electromagnetic coil assembly 43 can cancel out, so as to completely eliminate the eccentric wear, excessive partial abrasion and stress generated on the anti-rotation stop due to the asymmetric magnetic field created by electromagnetic coil.

In order to create a completely even magnetic field, the amount of the break grooves 45 of the inner frame 41 equals to the amount of the break grooves 45 of the outer shell 42. The location of one of the break grooves 45 of the inner frame 41 should correspond to the location of one of the break grooves 45 of the outer shell 42. Namely, one of the break grooves 45 of the inner frame 41 and one of the break grooves 45 of the outer shell 42 locate at the same radial direction of the structure of the electromagnetic coil.

As a specific form of connection between the inner frame 41 and the outer shell 42, two annular outer edges are respectively disposed on two ends of the inner frame 41. An axis of the outer edges and an axis of the body portion of the inner frame 41 are collinear. An inner hole of the outer edges is connected to the two ends of the inner frame 41. The break grooves 45 of the inner frame 41 extend to an outer end of the outer edges. An external diameter of the outer shell 42 is no more than an external diameter of the outer edges, and the outer shell 42 is engaged between the two outer edges. An insulating layer 47 is disposed between each one of the outer edges and a corresponding end of the outer shell 42, wherein the insulating layer could employ a mica material; and the annular cavity is an enclosed structure. With the aforementioned connecting form, the relative position of the inner frame 41 and the outer shell 42 can be firmly fixed, facilitating to keep the performance of the electromagnetic coil. The enclosed structure of the annular cavity aims to protect the electromagnetic coil winding 43.

Furthermore, to better protect the coil winding 43, a potting insulation layer 44 is disposed between the coil winding 43 and the outer shell 42, wherein the potting insulation layer 44 is a cylindrical structure obtained by vacuum pouring of the insulating varnish and the silica sand, and then solidification at high temperature.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

1. What is claimed is:

1. A reactor control rod driving mechanism, comprising a sealing shell assembly, a travel casing fixedly connected to the sealing shell assembly, a coil assembly sleeved on the sealing shell assembly, and a hook assembly disposed in the sealing shell assembly, wherein the sealing shell assembly comprises a sealing shell and a tube base, and the sealing shell and the tube base form an integral structure.

2. The reactor control rod driving mechanism as claimed in claim 1, wherein the hook assembly comprises a buffer shaft and a movable armature, and each of the buffer shaft and the movable armature has a cylindrical structure; the buffer shaft is a stepped shaft, and the movable armature comprises an inner bore in a form of a stepped bore; the movable armature is sleeved onto an outer side of the buffer shaft, and a first diameter changing section of the outer side of the buffer shaft faces directly to a second diameter changing section of the inner bore of the movable armature; when the buffer shaft and the movable armature move relative to each other, a relative position of the buffer shaft and the movable armature is limited due to a contact between the first diameter changing section and the second diameter changing section; and the first diameter changing section is connected to a smaller diameter end of the buffer shaft through a rounding or a first chamfer, wherein a size of the rounding ranges from R0.6 to R5, and a size of the first chamfer ranges from 2×45° to 4×45°.

3. The reactor control rod driving mechanism as claimed in claim 2, wherein a second chamfer is disposed on a smaller diameter end of the second diameter changing section, and a size of the second chamfer ranges from 2.5×45° to 3.2×45°.

4. The reactor control rod driving mechanism as claimed in claim 2, wherein a material of the buffer shaft is any of an austenitic stainless steel, a nickel based alloy or a cobalt based alloy, and the movable armature is consisted of a martensitic stainless steel.

5. The reactor control rod driving mechanism as claimed in claim 1, wherein the coil assembly comprises an inner frame and an outer shell each having a cylindrical structure, and an annular cavity for accommodating a coil winding formed between the outer shell and the inner frame, wherein the inner frame is disposed in an inner hole of the outer shell; each of the inner frame and the outer shell comprises a metal body portion and one or more break grooves disposed on the body portion; and the break grooves of the inner frame extend through an inner wall, an outer wall, a front end face and a rear end face of the inner frame, and the break grooves of the outer shell extend through an inner wall, an outer wall, a front end face and a rear end face of the outer shell.

6. The reactor control rod driving mechanism as claimed in claim 5, wherein the one or more break grooves of the inner frame or the outer wall comprise at least two break grooves; the break grooves of the inner frame are distributed evenly on the body portion of the inner frame, and the break grooves of the outer shell are distributed evenly on the body portion of the outer shell; and an insulative connecting strip is disposed in each one of the break grooves.

7. The reactor control rod driving mechanism as claimed in claim 6, wherein the insulative connecting strip of the inner frame comprises an insulating strip embedded or inlaid in the break grooves of the inner frame; two engagement grooves or two engagement convex portions disposed on the outer shell are respectively located on two sides of each one of the break grooves of the outer shell; a longitudinal direction of the engagement grooves or the engagement convex portions is in parallel with an axial direction of the outer shell, and the engagement grooves or the engagement convex portions originate at one end of the outer shell; and the insulative connecting strip of the outer shell comprises an insulating engagement strip connecting to two engagement grooves or the engagement convex portions of any one of the break grooves of the outer shell.

8. The reactor control rod driving mechanism as claimed in claim 5, wherein two annular outer edges are respectively disposed on two ends of the inner frame, and an axis of the outer edges and an axis of the body portion of the inner frame are collinear; an inner hole of the outer edges is connected to the two ends of the inner frame, and the break grooves of the inner frame extend to an outer end of the outer edges; an external diameter of the outer shell is no more than an external diameter of the outer edges, and the outer shell is engaged between the two outer edges; an insulating layer is disposed between each one of the outer edges and a corresponding end of the outer shell; and the annular cavity is an enclosed structure.

9. The reactor control rod driving mechanism as claimed in claim 1, wherein each of the sealing shell and the tube base has a tubular structure forged by a nickel based alloy material.

10. The reactor control rod driving mechanism as claimed in claim 1, further comprising a rod position indicating assembly sleeved onto the sealing shell assembly.
